(19) United States
(12) Patent Application Publication
(10) Pub. No.: US 2006/0141193 A1
(43) Pub. Date: Jun. 29, 2006

(54) Masking stick for household paint job

(76) Inventor: Steve Karaga, Lawrenceville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/025,393

(22) Filed: Dec. 29, 2004

(51) Int. Cl. B32B 33/00

(52) U.S. Cl. 428/40.1; 428/194

(57) ABSTRACT

Disclosed are apparatuses and methods for a masking stick that facilitates painting a household. In one embodiment, a masking stick includes a rigid backing layer having rigidity to maintain a substantially straight line without external force and flexibility to flow with irregularities or curves on an edge of a painting surface to be protected. The masking stick further includes an adhesive layer having adhesive that is placed on a top surface of the rigid backing layer. The adhesive is strong enough to hold the rigid backing layer securely, but can be easily removed without causing damage to the painting surface. The adhesive layer covers at least a portion of rigid backing layer. A method for masking a painting surface is provided herein using the masking stick as mentioned above.

### TECHNICAL FIELD

The present invention relates to a masking stick for household paint job, and more particularly, a masking stick that includes a rigid material that enables a user to easily align the stick along an edge of a household painting surface.

### BACKGROUND

The worst part of any household paint job is masking corners and edges of walls, windows, doors, etc. in a house. Typically, masking tapes available in the market nowadays includes a backing layer that has characteristics of a thin paper. Because of the thin paper characteristics, the masking tape folds and rolls onto itself and at times is very difficult for the user to mask the edges and corners of the painting area. It is very slow going and frustrating to place the paper-like masking tape straight along the edges.

Thus, a heretofore unaddressed need exists in the industry to address the aforementioned deficiencies and inadequacies.

### SUMMARY OF THE DISCLOSURE

Disclosed are apparatuses and methods for a masking stick that facilitates painting a household. In one embodiment, a masking stick includes a rigid backing layer having rigidity to maintain a substantially straight line without external force and flexibility to flow with irregularities or curves on an edge of a painting surface to be protected. It is preferable that the rigid backing layer is made of paper card stock having a basis weight of approximately 170 g/m²-275 g/m² with a Taber Stiffness of approximately 1.3 CD, mNm (or 2.8 MD, mNm)-6.7 CD, mNm (or 13.5 MD, mNm). The masking stick further includes an adhesive layer having adhesive that is placed on a top surface of the rigid backing layer. The adhesive is strong enough to hold the rigid backing layer securely, but can be easily removed without causing damage to the painting surface. The adhesive layer covers at least a portion of rigid backing layer.

In another embodiment, a method for masking a painting surface includes providing a masking stick as mentioned above. The adhesive layer is revealed so that the masking stick can mask the painting surface. The masking stick can be aligned along the substantially straight edge of the painting surface because the masking stick has a rigid backing layer that has the rigidity to maintain a straight line without external force and flexibility to flow with irregularities or curves on the edge of the painting surface to be protected. The adhesive layer is then pressed onto a masking area of the painting surface along the substantially straight edge of the painting surface.

Other apparatus, methods, features, and advantages of the present invention will be or become apparent to one with skill in the art upon examination of the following drawings and detailed description. It is intended that all such additional apparatus, methods, features, and advantages be included within this description, be within the scope of the present invention, and be protected by the accompanying claims.

### BRIEF DESCRIPTION OF THE DRAWINGS

The disclosed apparatuses and methods can be better understood with reference to the following drawings. The components in the drawings are not necessarily to scale.

FIG. 1 is a perspective view of a masking stick that facilitates painting a household.

FIG. 2 is a cross-sectional view of the masking stick shown in FIG. 1.

FIG. 3 is a perspective view of an alternative embodiment of a masking stick.

FIG. 4 is a cross-sectional view of the masking stick shown in FIG. 3.

FIG. 5 is a flow diagram that illustrates an embodiment of operation of masking a painting surface using the masking sticks shown in FIGS. 1-4.

### DETAILED DESCRIPTION OF THE PREFERRED EMBODIMENT

Disclosed are apparatuses and methods for a masking stick that facilitates painting a household. In one embodiment, the masking stick includes a rigid backing layer that is made of a substrate having rigidity to maintain a straight line without external force and flexibility to flow with minor irregularities or curves on the edges to be protected. The rigid backing layer can naturally straighten and extend itself longitudinally when no force is applied to it. For example, if the backing layer is maintained in a roll by way of a rubber band, the backing layer of the masking stick can straighten and extend itself longitudinally when the robber band is taken off of the backing layer. The substrate of the backing layer can be made of paper card stock, laminated paper or plastic. More particularly, the substrate can be polyethylene, propylene, paper, sheet plastic extrusion, or resins. The preferred substrate is paper card stock that has a basis weight of approximately 170 g/m²-275 g/m² with a Taber Stiffness of approximately 1.3 CD, mNm (or 2.8 MD, mNm)-6.7 CD, mNm (or 13.5 MD, mNm).

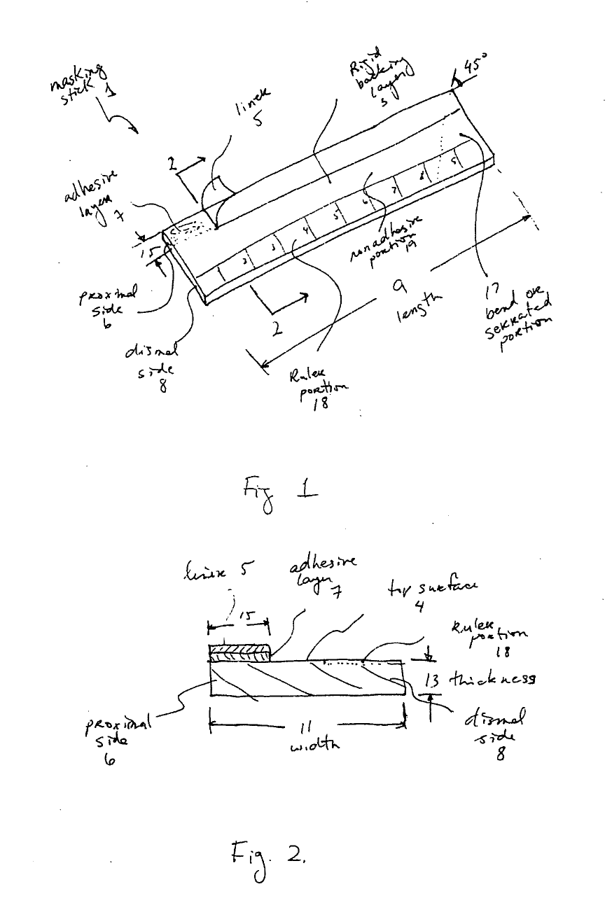

Referring now in more detail to the figures in which like reference numerals identify corresponding parts, FIG. 1 is a perspective view of a masking stick that facilitates painting a household. The length 9 of the masking stick is preferably four (4) feet long. The masking stick 1 includes a rigid backing layer 3, an adhesive layer 7, a non-adhesive portion 19, and a liner 5. The adhesive layer 7 and the liner 5 are located at a proximal side 6 of the masking stick 1. The adhesive layer 7 is covered by the liner 5 that is removed immediately prior to use revealing adhesive that is strong enough to hold the rigid backing layer 3 securely, but can be easily removed without causing damage to common painted surfaces. The liner 5 covers the adhesive layer 7 to protect the surface of the adhesive layer 7 before the masking stick 5 is used to mask the edges of a painting surface.

The nonadhesive portion 19 is located at a dismal side 8 of the masking stick 5 and facilitates ease of handling of the masking stick 5 because no adhesive is applied on the nonadhesive portion 19. The user can hold on to the nonadhesive portion 19 particularly when the user masks the masking stick 1 on the edge of the painting surface. The backing layer 3 can be made of polyethylene, propylene, laminated paper, paper, sheet plastic extrusion, or resins. It is preferable that the backing layer 3 be made of paper card stock having a basis weight of approximately 170 g/m²-275 g/m² with a Taber Stiffness of approximately 1.3 CD, mNm (or 2.8 MD, mNm)-6.7 CD, mNm (or 13.5 MD, mNm). The other materials, such as polyethylene, propylene, laminated paper, sheet plastic extrusion, or resins has characteristics of rigidity that is similar to the paper card stock having a basis weight of approximately 170 g/m²-275 g/m² with a Taber Stiffness of approximately 1.3 CD, mNm (or 2.8 MD, mNm)-6.7 CD, mNm (or 13.5 MD, mNm). The rigid backing layer 3 allows enough rigidity to maintain the straight line easily while offering enough flexibility to flow with minor irregularities or curves on the surface to be protected.

In an alternative embodiment, the rigid backing layer 3 can include a bend or serrated portion 17 of approximately 45 degrees to allow bends of 90 degrees around corners of the painting surface. The rigid backing layer 3 can be made in various lengths and widths to accommodate various painting applications. The rigid backing layer 3 can be manufactured in various shapes such as 90 degree bend portions and 90 degree flat cut-off sections which can be used for various painting applications such as window and door moldings. In an alternative embodiment, the rigid backing layer 3 can further include a ruler portion 18, which can be marked like a ruler to facilitate ease of cutting the masking stick 1 to various sizes to accommodate the user in masking the painting surface. The ruler portion 18 can be located at the dismal side 8 of the masking stick 1.

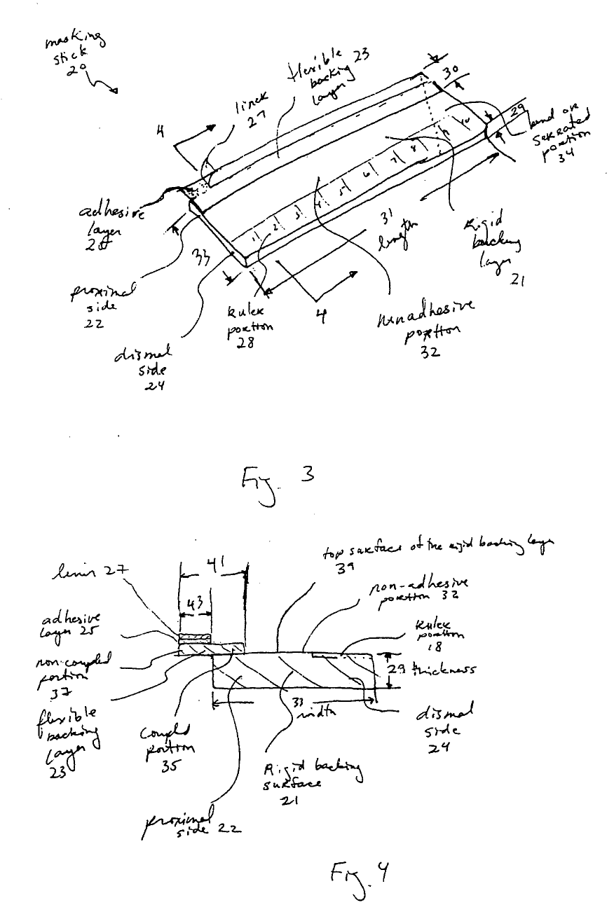

FIG. 2 is a cross-sectional view of the masking stick that is made of paper card stock shown in FIG. 1. FIG. 2 shows the width 11 of the masking stick 1, which is approximately three (3) inches, and the thickness 13, which is approximately eight (8) to twenty (20) point stock. The adhesive layer 7 is placed on a top surface 4 of the masking stick 1 and covers a portion of the width 11 of the masking stick 1. The liner 5 covers the adhesive layer 7 to protect the adhesive layer 7 before the use of the masking stick 1. As mentioned above, the liner 5 and the adhesive layer 7 are placed at a proximal side 6 of the masking stick 1 and the ruler portion 18 at a dismal side 8 of the masking stick 1. The adhesive layer 7 and the liner 5 cover at least a portion of the masking stick 1, preferably the width being approximately ⅜ to ½ inch and the length being approximately four (4) feet. In an alternative embodiment, the adhesive layer 7 and the liner 5 can cover the entire top surface 4 of the rigid backing layer 3.

FIG. 3 is a perspective view of an alternative embodiment of a masking stick. The masking stick 20 in FIG. 3 is similar to the masking stick 1 described above, and therefore, also includes a rigid backing layer 21, a liner 27, a nonadhesive portion 32, and an adhesive layer 25. As mentioned with reference to the rigid backing layer 3 in relation to FIG. 1, the rigid backing layer 21 in FIG. 3 can also be made of polyethylene, propylene, laminated paper, paper, sheet plastic extrusion, or resins. The length 9 of the masking stick is also preferably four (4) feet long as in masking stick 1 in FIG. 1. The masking stick 20 in FIG. 3 further includes a flexible backing layer 23 at a proximal side 22 of the masking stick 20. The flexible backing layer is made of paper having a basis weight of less than 170 g/m² with a Taber Stiffness of less than 1.3 CD, mNm (or 2.8 MD, mNm). The width 30 of flexible backing layer 23 is preferably approximately one (1) inch and the length is approximately the length of the masking stick 20. The flexible backing layer 23 can be coupled to the rigid backing layer 21 by way of an adhesive that is stronger than the adhesive used for the adhesive layer 25. A coupled portion 35 (shown in FIG. 4) of the flexible backing layer 23 is coupled to the rigid backing layer 21 and the non-coupled portion 37 (shown in FIG. 4) is dangling off the edge of the proximal side 22 of the masking stick 20.

The adhesive layer 25 is placed on a top surface 26 of the flexible backing layer 23. The adhesive layer 25 and the liner 27 covers at least a portion of the flexible backing layer 25, preferably the width being approximately ⅜ to ½ inch and the entire length of the flexible backing layer 25. It is preferred that the adhesive layer 25 is placed on the side of the non-coupled portion 37 of the flexible backing layer 23. In an alternative embodiment, the adhesive layer 25 can cover the entire top surface 26 of the flexible backing surface. The adhesive layer 25 is covered by the liner 27 that is removed immediately prior to use revealing adhesive that is strong enough to hold the flexible backing layer 23 securely, but can be easily removed without causing damage to common painted surfaces. The liner 5 covers the adhesive layer 7 to protect the surface of the adhesive layer 25 before the masking stick 20 is used to mask the edges of a painting surface.

The nonadhesive portion 32 facilitates ease of handling of the masking stick 20. The user can hold on to the nonadhesive portion 30 particularly when the user masks the masking stick 20 on the edge of the painting surface. In an alternative embodiment, the rigid backing layer 21 can include a bend or serrated portion 34 of approximately 45 degrees to allow bends of 90 degrees around corners of the painting surface. In another alternative embodiment, the rigid backing layer 21 can further include a ruler portion 28, which can be marked like a ruler to facilitate ease of cutting the masking stick 20 to various sizes to accommodate the user in masking the painting surface.

FIG. 4 is a cross-sectional view of the masking stick that is made of paper card stock shown in FIG. 3. FIG. 4 shows the width 33 of the masking stick 20, which is approximately three (3) inches, and the thickness 23, which is in the range of eight (8) to twenty (20) point stock. The flexible backing layer 23 is placed on a top surface 39 of the masking stick 20 and covers a portion of the width 33 of the masking stick 20. The flexible backing layer 23 includes a coupled portion 35 and a non-coupled portion 37. The coupled portion 35 is coupled to a proximal side 22 of the masking stick 20 on the top surface 39 of the rigid backing layer 21 and between the adhesive layer 25 and the rigid backing layer 21. The non-coupled portion 37 of the flexible backing layer 23 is dangling off the edge of the proximal side 22 of the masking stick 20. The preferred width 41 of the flexible backing layer is approximately one (1) inch and the length is approximately the length of the masking stick 20.

The adhesive layer 25 is placed on a top surface 26 of the flexible backing layer 23 and covers a portion of the width 41 of the flexible backing layer 23. It is preferred that the adhesive layer 25 is placed on the non-coupled portion 37 of the flexible backing layer 23. The adhesive layer 25 and the liner 27 cover at least a portion of the flexible backing layer 23, preferably the width 43 being approximately ⅜ to ½ inch and the length being approximately the same length of the masking stick 20. In an alternative embodiment, the adhesive layer 25 and the liner 27 cover the entire width 43 of the flexible backing layer 23. The liner 27 covers the adhesive layer 25 to protect the adhesive layer 25 before the use of the masking stick 20. The flexible backing layer 23, liner 27 and the adhesive layer 25 are placed at a proximal side 22 of the masking stick 20 and the ruler portion 28 at a dismal side 24 of the masking stick 20.

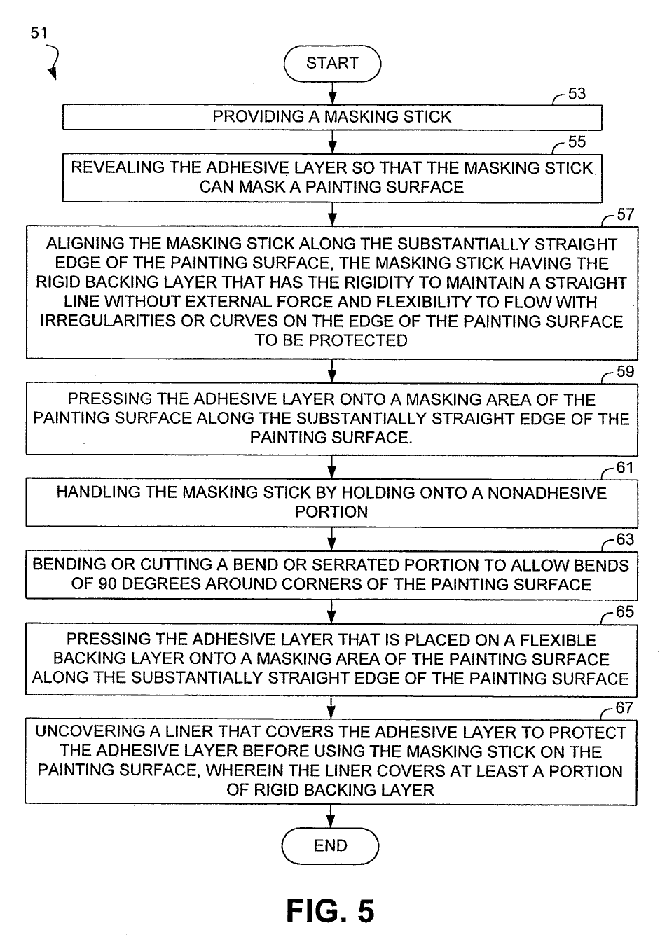

FIG. 5 is a flow diagram that illustrates an embodiment of operation of masking a painting surface using the masking sticks shown in FIGS. 1-4. The operation 51 for masking a painting surface includes, as shown in block 53, providing a masking stick that includes an adhesive layer and a rigid backing layer. The adhesive layer has adhesive that is placed on a top surface of the rigid backing layer. The adhesive is strong enough to hold the rigid backing layer securely, but can be easily removed without causing damage to the painting surface. The adhesive layer covers at least a portion of rigid backing layer. In an alternative embodiment, a flexible backing layer can be disposed between the rigid backing layer and the adhesive layer as explained in FIGS. 3-4.

In block 55, the adhesive layer is revealed so that the masking stick can mask a painting surface. It is an option that a liner can be used to cover the adhesive layer if the liner is used to protect the adhesive layer before using the masking stick on the painting surface. In block 57, the masking stick can be easily aligned the along the substantially straight edge of the painting surface because the masking stick has the rigid backing layer that has the rigidity to maintain a straight line without external force and flexibility to flow with irregularities or curves on the edge of the painting surface to be protected. The rigid backing layer is preferably made of paper card stock having a basis weight of approximately 170 g/m²-275 g/m² with a Taber Stiffness of approximately 1.3 CD, mNm (or 2.8 MD, mNm)-6.7 CD, mNm (or 13.5 MD, mNm).

In block 59, the adhesive layer is pressed onto a masking area of the painting surface along the substantially straight edge of the painting surface. It should be noted that the adhesive layer can be applied either on the rigid backing layer or the flexible backing layer or both. In block 61, the masking stick can be handled by way of holding onto a nonadhesive portion. In block 63, a bend or serrated portion of the masking stick can be bent or cut to allow bends of 90 degrees around corners of the painting surface. More particularly, the bend or serrated portion can be bent or cut off approximately 45 degrees.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A masking stick comprising:
a rigid backing layer having rigidity to maintain a substantially straight line without external force and flexibility to flow with irregularities or curves on an edge of a painting surface to be protected; and
an adhesive layer having adhesive that is placed on a top surface of the rigid backing layer, the adhesive is strong enough to hold the rigid backing layer securely, but can be easily removed without causing damage to the painting surface, wherein the adhesive layer covers at least a portion of rigid backing layer.

2. The masking stick of claim 1, wherein the rigid backing layer is made of one of polyethylene, propylene, paper, paper card stock, sheet plastic extrusion, and resins.

3. The masking stick of claim 1, further comprising a nonadhesive portion that facilitates ease of handling of the masking stick.

4. The masking stick of claim 1, wherein the rigid backing layer is made of paper card stock having a basis weight of approximately 170 g/m²-275 g/m² with a Taber Stiffness of approximately 1.3 CD, mNm (or 2.8 MD, mNm)-6.7 CD, mNm (or 13.5 MD, mNm).

5. The masking stick of claim 1, further comprising a bend or serrated portion of the masking stick to allow bends of 90 degrees around corners of the painting surface.

6. The masking stick of claim 5, wherein the bend or serrated portion is bend or cut off approximately 45 degrees.

7. The masking stick of claim 1, further comprising a ruler portion to facilitate ease of cutting the masking stick to various size to accommodate masking the painting surface.

8. The masking stick of claim 1, further comprising a flexible backing layer that is coupled to a proximal side of the masking stick on the top surface of the rigid backing layer and between the adhesive layer and the backing layer.

9. The masking stick of claim 8, wherein the flexible backing layer is coupled to the rigid backing layer by way of an adhesive that is stronger than the adhesive used for the adhesive layer 25.

10. The masking stick of claim 8, wherein a portion of the flexible backing layer is dangling off the edge of the proximal side of the masking stick.

11. The masking stick of claim 1, further comprising a liner that covers the adhesive layer to protect the adhesive layer before using the masking stick on the painting surface, wherein the liner covers at least a portion of rigid backing layer.

12. A method for masking a painting surface comprising:
providing a masking stick, the masking stick comprising:
a rigid backing layer; and
an adhesive layer having adhesive that is placed on a top surface of the rigid backing layer, the adhesive is strong enough to hold the rigid backing layer securely, but can be easily removed without causing damage to the painting surface; wherein the adhesive layer covers at least a portion of rigid backing layer,
revealing the adhesive layer so that the masking stick can mask a painting surface;
aligning the masking stick along the substantially straight edge of the painting surface, the masking stick having the rigid backing layer that has the rigidity to maintain a straight line without external force and flexibility to flow with minor irregularities or curves on the edge of the painting surface to be protected;
pressing the adhesive layer onto a masking area of the painting surface along the substantially straight edge of the painting surface.

13. The method of claim 12, further comprising handling the masking stick by holding onto a nonadhesive portion.

14. The method of claim 12, further comprising bending or cutting a bend or serrated portion to allow bends of 90 degrees around corners of the painting surface.

15. The method of claim 14, wherein bending or cutting off approximately 45 degrees the bend or serrated portion.

16. The method of claim 12, wherein the masking stick further comprising a flexible backing layer that is coupled to a proximal side of the masking stick on the top surface of the rigid backing layer and between the adhesive layer and the backing layer, wherein a portion of the flexible backing layer is dangling off the edge of the proximal side of the masking stick.

17. The method of claim 16, wherein pressing the adhesive layer that is placed on the flexible backing layer onto a masking area of the painting surface along the substantially straight edge of the painting surface

18. The method of claim 12, further comprising uncovering a liner that covers the adhesive layer to protect the adhesive layer before using the masking stick on the painting surface, wherein the liner covers at least a portion of rigid backing layer
